(19) United States
(12) Patent Application Publication
(10) Pub. No.: US 2013/0144949 A1
(43) Pub. Date: Jun. 6, 2013

(54) Crowd-Sourced Resource Selection in a Social Network

(71) Applicants: Donald Le Roy Mitchell, JR., Bellevue, WA (US); Thomas Ginter, Bellevue, WA (US); Firdaus Aryana, Seattle, WA (US); William M. Hughes, Bellevue, WA (US)

(72) Inventors: Donald Le Roy Mitchell, JR., Bellevue, WA (US); Thomas Ginter, Bellevue, WA (US); Firdaus Aryana, Seattle, WA (US); William M. Hughes, Bellevue, WA (US)

(21) Appl. No.: 13/487,648

(22) Filed: Jun. 4, 2012

Related U.S. Application Data
(60) Provisional application No. 61/457,790, filed on Jun. 3, 2011.

(51) Int. Cl. H04L 29/08

(52) U.S. Cl. CPC H04L 67/32
USPC 709/204

(57) ABSTRACT

A resource selection server that performs crowd-sourced resource selection over a social networking service, absent a central ratings database. A device subscribed to a social networking service implementing the inventive resource selection server, may register as a resource offering a particular skill. Additionally, any device subscribed to a relevant social networking service may transmit a skill request to the inventive resource selection server, to request a best-fit resource be returned for a particular skill of interest. The resource selection server queries a subscriber account database to identify resources on a social networking service, registered to offer a requested skill. The resource selection server additionally prompts subscriber devices within ‘n’ degrees of separation of a requesting device, to submit real-time trust ratings for resources complying with a particular skill request. The resource selection server analyzes ratings submitted by selected subscriber devices to return a best-fit resource for a particular skill request.

The present application claims priority from U.S. Provisional No. 61/457,790, entitled “Crowd-Sourced Resource Selection in A Social Network”, to Mitchell et al., filed Jun. 3, 2011; the entirety of which is explicitly incorporated herein by reference.

### BACKGROUND OF THE INVENTION

1. Field of the Invention

This invention relates generally to social networking devices. More particularly, it relates to social networking devices based on the Internet or enterprise networks.

2. Background of the Related Art

A social network is created by a number of communication devices interconnected over a network based communication medium. A mapping of a social network represents the relationships established amongst digital devices integrated therein.

A device subscribed to a social networking service may construct a personal social network. A personal social network constructed by a particular subscriber device, typically includes the devices with which that particular subscriber device maintains a direct relationship (e.g., a connection via direct link on a social network). A ‘friend’ of a subscriber device, refers to any device directly linked within a personal social network originated by that particular subscriber device.

Every ‘friend’ device linked within a personal social network is marginally connected via common affiliation to an originating subscriber device. Consequently, each addition/deletion performed on a personal social network, provokes an updated mapping of all network devices connected via association therein.

The strength of a relationship established amongst any two devices mapped within a social network, may be measured in degrees of separation.

FIG. 3 depicts degrees of separation separating devices mapped within a conventional social network.

In particular, a ‘friend’ device 320 linked within a personal social network 300 attributed to a particular subscriber device 310, is one degree of separation away from that particular subscriber device 310. Moreover, a ‘friend’ device 330 linked within a personal social network 340 attributed to a ‘friend’ device 320 of the particular subscriber device 310, is two degrees of separation away from that particular subscriber device 310 (as long as the ‘friend’ device 330 is not additionally linked within the personal social network 300 in a closer relationship with the particular subscriber device 310).

Connections established amongst devices 310, 320, 330 mapped within a social network 340 often generate a plethora of information resources. Furthermore, an ability to effortlessly communicate and share information over the web, has altered the manner in which many operations are performed today, particularly business operations.

The present inventors have appreciated that network based resource selection services are beginning to greatly influence consumer purchasing trends. For instance, numerous devices may browse quality ratings and/or reviews presented on resource selection services, to obtain relevant information and/or recommendations prior to investing in a particular product/service. Consumers are likely to invest more money in products/services with higher average consumer ratings. Consequently, businesses are placing greater emphasis on marketing strategies geared towards sources of web-based consumer information.

Although social networking services promote easy consolidation and dissemination of information, the amount of information available on a social network is so expansive, that devices are having difficulty determining what information is actually relevant and/or trustworthy, and what information is not.

A conventional trust based resource selector filters information accumulated over a social network. A trust based system enables a subscriber device to articulate a trust rating for other devices also subscribed to a relevant social network. A trust rating signifies how much confidence one subscriber device maintains in the judgment/opinion of another subscriber device.

A subscriber device employing a conventional trust based resource selector may browse consumer ratings and/or reviews submitted by devices for which that subscriber device has indicated a high level of trust. Hence, data accumulated on a social network, may be filtered by a trust based resource selector via proclamations of trust, to provide relevant/particular information to individual subscriber devices. Additionally, a trust based resource selector leads to a higher quality of service, as resources offering skilled services work to gain a positive reputation.

Resource selection schemas currently implicated on social networks are database driven. A database driven resource selection service stores all consumer ratings and/or reviews in a central ratings database, for retrieval upon user request.

Unfortunately, consumer ratings and/or reviews stored in a central ratings database run a risk of being compromised. A breach of privacy on a database driven social network is likely detrimental to both a particular service subscriber, as well as to the compromised social networking service.

Additionally, ratings and/or reviews stored in a central ratings database on a resource selection service may potentially grow stale and irrelevant over time. Old and irrelevant ratings and/or reviews may cause users to become skeptical as to the validity of information presented on such a service, potentially motivating users to look elsewhere for personalized consumer information.

Moreover, the integrity of ratings and/or reviews stored in a central ratings database may be easily compromised. In particular, current resource selection services permit resources to easily construe and submit their own ratings and/or reviews, and/or solicit other subscriber devices to submit ratings and/or reviews, to promote a particular resource, and/or to deter users from a competing resource.

### SUMMARY OF THE INVENTION

In accordance with the principles of the present invention, a method of providing crowd-sourced resource selection on a social networking service absent a ratings database, comprises a resource selection server.

In accordance with the principles of the present invention, the inventive resource selection server enables a device subscribed to a social networking service to register as a resource offering a particular skill. In addition, a device subscribed to a social networking service employing the inventive resource selection server, is required to designate a trust rating for every device mapped within a personal social network derived by that particular subscriber device.

In accordance with the principles of the present invention, skill requests are transmitted to the inventive resource selection server, by any subscriber device requesting a best-fit resource for a particular skill. The inventive resource selection server utilizes a database of subscriber trust levels and skills to identify resources subscribed to the service that are registered to offer requested skills.

In accordance with the principles of the present invention, subscribers within ‘n’ degrees of separation of a requesting device are prompted to submit real-time trust ratings (i.e. proposed skill levels) for potential resources identified for a particular skill request. Based on submitted trust ratings, the resource selection server computes an aggregate trust factor for each potential resource identified during resource selection. Resources with the top ‘n’ trust factors are returned to a requestor in response to a transmitted skill request.

### BRIEF DESCRIPTION OF THE DRAWINGS

Features and advantages of the present invention will become apparent to those skilled in the art from the following description with reference to the drawings, in which:

FIG. 1 depicts an exemplary network structure for a resource selection server implemented over a social networking service, in accordance with the principles of the present invention.

FIG. 2 depicts an exemplary process of crowd-sourced resource selection via a resource selection server on a social networking service, in accordance with the principles of the present invention.

FIG. 3 depicts degrees of separation separating devices mapped within a conventional social network.

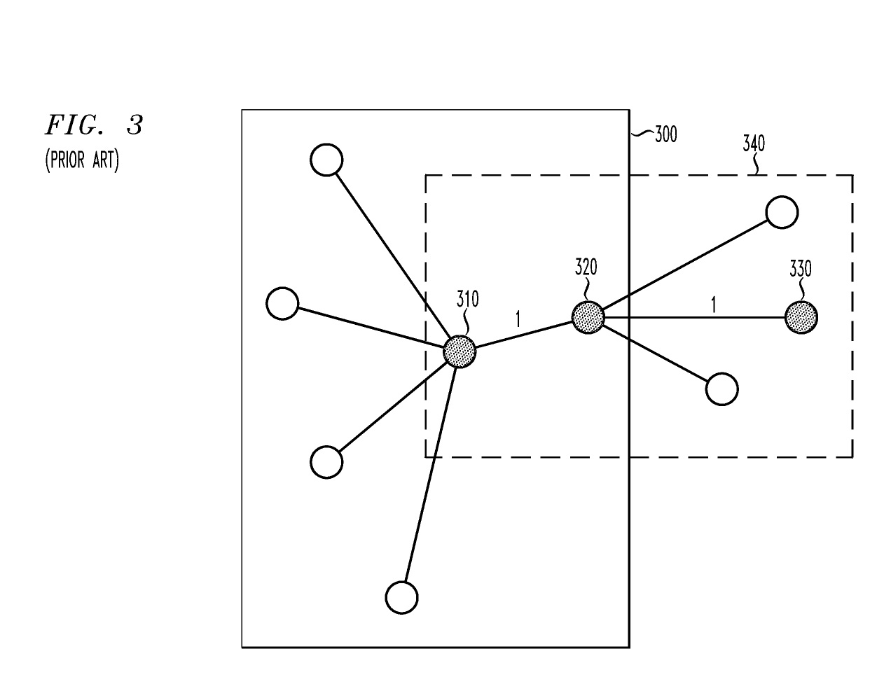

### DETAILED DESCRIPTION OF ILLUSTRATIVE EMBODIMENTS

The present invention provides a resource selection server that performs crowd-sourced resource selection over a social networking service, absent a ratings database. The inventive resource selection server negates the need to maintain a ratings database, by prompting devices subscribed to a social networking service to submit real-time trust ratings for resources meeting subscriber-initiated skill requests. The resource selection server analyzes ratings submitted by various subscriber devices to select a best-fit resource for each skill request that is transmitted to the resource selection server. Data obtained and analyzed during the resource selection process is not stored for future use.

In accordance with the principles of the present invention, any device subscribed to a social networking service implementing the inventive resource selection server, may register as a resource offering a particular skill. During resource registration, a subscriber device submits a trust rating (e.g. a numerical rating on a scale of one to ten) and appropriate heuristics (e.g. days of operation, hours of operation, location, etc.), relevant to each skill that is being offered. A trust rating submitted by a registered resource, signifies a self-proclaimed skill level pertaining to a particular skill the resource is registering to offer. Resource registration information is stored in a database of subscriber trust levels and skills. In accordance with the principles of the present invention, account maintenance procedures repeatedly prompt registered resources to update personal trust ratings to prevent previously stored trust ratings from growing stale.

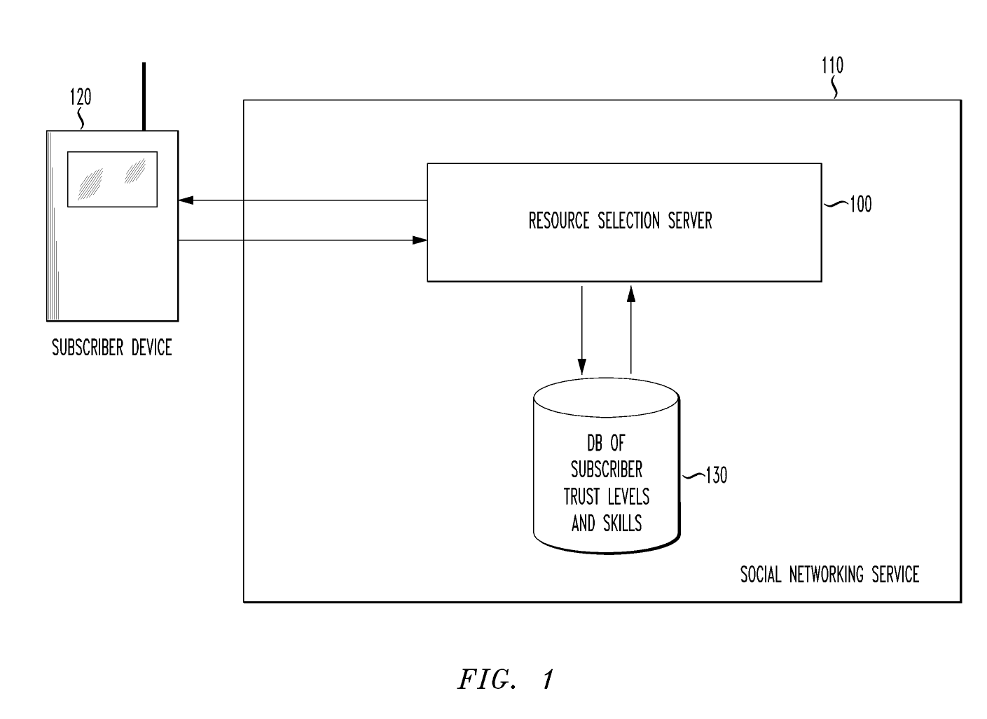

FIG. 1 depicts an exemplary network structure for a resource selection server implemented over a social networking service, in accordance with the principles of the present invention.

In particular, resources adhering to subscriber-initiated skill requests are retrieved via a resource selection server 100, operative over a social networking service 110. A subscriber device 120 on a social networking service 110 interacts with the resource selection server 100, e.g., to transmit a skill request, to receive a best-fit resource, to submit a trust rating, etc., via a conventional method of data transmission, e.g., Short Message Service (SMS), Instant Messenger service (IM), etc.

The inventive resource selection server 100 utilizes a database of subscriber trust levels and skills 130 to store subscriber account information and subsequent ongoing account maintenance results. The resource selection server 100 additionally queries the database of subscriber trust levels and skills 130 to compile a list of potential resources for each skill request that is received thereon.

The inventive resource selection server 100 requires that a trust rating be submitted, before a direct relationship may be established between any two devices subscribed to a corresponding social networking service 110. Thus, each subscriber device 120 on a relevant social networking service 110 must designate a trust rating for every other device linked within an affiliated personal social network. A trust rating (e.g. a numerical rating on a scale of one to ten) signifies the trust one subscriber device 120 maintains in the judgment/opinion of another subscriber device. Hence, a trust rating submitted for a registered resource, preferably signifies the trust a submitting subscriber device 120 maintains in the accuracy of the personal skill rating previously stored by that registered resource. Moreover, a trust rating submitted by one subscriber device 120 for another subscriber device (that is not a registered resource), preferably signifies the level of trust the submitting subscriber device 120 maintains in the validity of any trust rating (e.g. a trust rating submitted for a registered resource, a trust rating submitted for a ‘friend’, an ‘acquaintance’, etc.) submitted by the other particular subscriber device. In accordance with the principles of the present invention, account maintenance procedures repeatedly prompt subscriber devices to update trust ratings to prevent previously stored trust ratings from growing stale.

A baseline data collection process is performed for each device 120 subscribed to a social networking service 110 implementing the inventive resource selection server 100. In accordance with the principles of the present invention, baseline data collection is performed during account subscription and ongoing account maintenance procedures, to maintain an accurate network of relationships, skills, and trust levels amongst acquainted subscriber devices 120. In accordance with the principles of the present invention, a subscriber device 120 transmits a skill request to the resource selection server 100 to request a best-fit resource for a particular skill of interest. A subscriber device 120 that transmits a skill request to the resource selection server is termed a ‘requestor’, in accordance with the principles of the present invention. A subscriber device 120 remains a ‘requester’ until the resource selection server returns a resource to that particular subscriber device, matching selection criteria supplied in a transmitted skill request.

Selection criteria supplied in a skill request comprises two components: a skill of interest and relevant heuristics, e.g., desired day of service, desired time of service, desired location of resource, etc. For instance, a message field of an exemplary skill request may, e.g., request a skill “Y”, from someone within 15 minutes of their home (heuristic), that can work after 6 pm on MWF (heuristic) from dates ##/##/#### to ##/##/#### (heuristic).

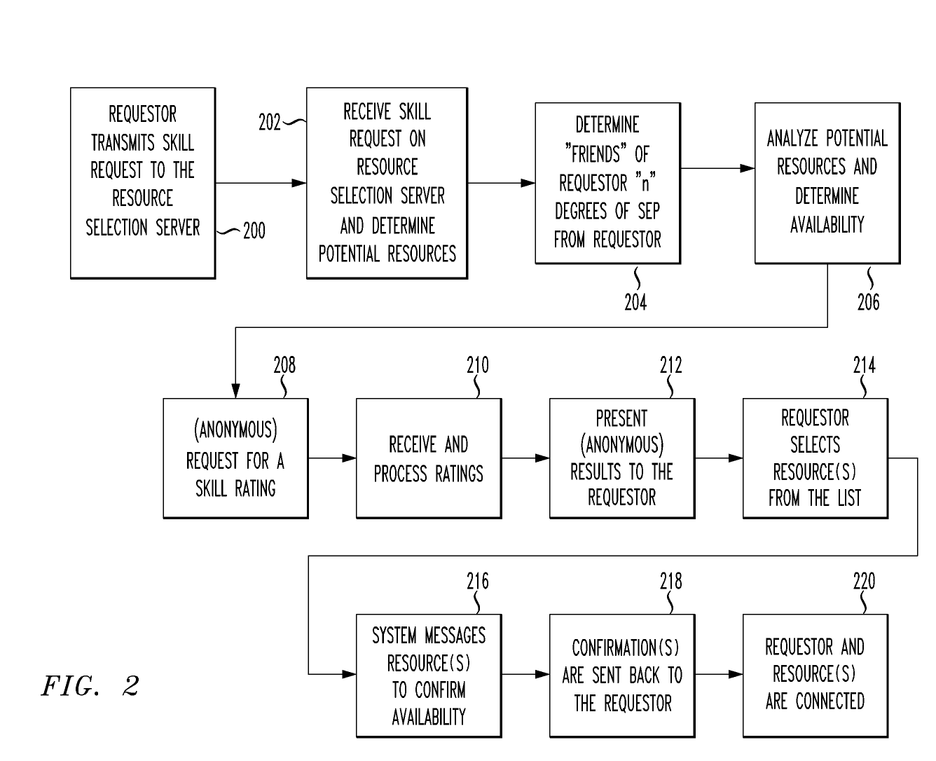

FIG. 2 depicts an exemplary process of crowd-sourced resource selection via a resource selection server on a social networking service, in accordance with the principles of the present invention.

In step 200, a requestor (i.e. a requesting device 120 subscribed to a social networking service 110) submits a skill request to the resource selection server 100, describing a particular skill of interest and relevant resource heuristics, e.g., preferred location, preferred hours of availability, preferred days of availability, etc. The skill request is transmitted to the resource selection server 100 via a conventional method of data transmission, e.g., Short Message Service (SMS), Instant Messenger service (IM), etc.

In step 202, the resource selection server 100 receives the skill request transmitted by the requesting device 120. Upon receipt, the resource selection server 100 queries a database of subscriber trust levels and skills 130, to compile a list of resources that meet the skill/heuristics combination supplied within the transmitted skill request.

In step 204, the resource selection server 100 identifies subscriber devices (e.g. ‘friends’, ‘acquaintances’, etc.) within ‘n’ (configurable) degrees of separation of the requestor. Once identified, the resource selection server 100 compiles a list of devices within ‘n’ degrees of separation of the requesting device 120, that also have a trust rating stored in the database of subscriber trust levels and skills 130 for a potential resource identified (in step 202) for the relevant skill requested.

In step 206, the resource selection server 100 arranges potential resources (discovered in step 202) in an order from greatest to least best-fit match. Potential resources are ordered according to personal trust ratings stored by identified potential resources, as well as trust ratings obtained from subscribers within ‘n’ degrees of separation of the requesting device 120. In a preferred embodiment, the resource selection server 100 subsequently messages (or otherwise communicates with) each potential resource, in order of greatest to least best-fit match, to verify the availability of each resource in regards to the skill/heuristics combination identified in the transmitted skill request. The resource selection server 100 subsequently updates the list of potential resources in light of current availability.

In step 208, subscriber devices within ‘n’ degrees of separation of the requesting device 120, having a trust rating stored for a potential resource, are prompted to submit a trust rating (i.e. a skill-level rating) for a resource/skill combination corresponding to the relevant skill request (transmitted in step 200). An appropriate subscriber device is preferably prompted to submit a trust rating (i.e. a skill level rating) for the same potential resource for which that particular subscriber device has previously stored a trust rating. Interaction between the resource selection server 100 and a selected subscriber device is preferably performed in real-time, via a conventional method of data transmission, e.g., Short Message Service (SMS), Instant Messenger service (IM), etc.

In step 210, the resource selection server 100 receives and analyzes real-time trust ratings submitted by selected subscriber devices within ‘n’ degrees of separation of the requesting device 120. The resource selection server 100 subsequently computes an aggregate trust factor for each potential resource, reflecting the average trust rating each resource has received from selected subscriber devices.

In step 212, the resource selection server 100 returns resources with the top “n” aggregate trust factors to the requesting device 120, via a conventional method of data transmission, e.g., Short Message Service (SMS), Instant Messenger service (IM), etc. The top ‘n’ potential resources represent those resources registered on the relevant social networking service 110 that are best-fit to fulfill a particular skill request.

In step 214, the requesting device 120 receives the list of best-fit resources returned by the resource selection server 100, and selects one or more best-fit resources for potential fulfillment of the corresponding skill request. The requesting device 120 subsequently transmits a list of selected best-fit resources to the resource selection server 100, via a conventional method of data transmission, e.g., Short Message Service (SMS), Instant Messenger service (IM), etc.

In step 216, the resource selection server 100 messages each best-fit resource supplied in the list of best-fit resources selected by the requesting device 120, to confirm availability for the skill/heuristics combination depicted in the relevant skill request.

In step 218, the resource selection server 100 transmits a list of selected resources with confirmed availability to the requesting device 120, via a conventional method of data transmission, e.g., Short Message Service (SMS), Instant Messenger service (IM), etc.

In step 220, the requesting device 120 and selected best-fit resource(s) are directly connected using a known method (e.g. Short Message Service (SMS)), via a delivery mechanism that retains the anonymity of the requesting device 120 and/or resource(s).

The present invention has applicability to virtually any social networking service.

In accordance with the principles of the present invention, subscriber ratings used to perform resource selection on a social networking service 110 are collected in real-time, to assure subscriber ratings are always current.

The present invention promotes greater interaction within a social network 110, as subscriber devices work to enhance personal trust level(s) (i.e. reputation(s)).

While the invention has been described with reference to the exemplary embodiments thereof, those skilled in the art will be able to make various modifications to the described embodiments of the invention without departing from the true spirit and scope of the invention.

What is claimed is:

1. A method of brokering a resource associated with a subscriber device in a social network with another subscriber device in said social network, comprising:
registering, from a first social network subscriber device, a given resource associated with said first social network subscriber device, to be brokered in a social network database;
receiving, from a second social network subscriber device, a specific resource request;
comparing said specific resource request with available registered resources to identify said given resource; and
providing an identity of said first social network subscriber device to said second social network subscriber device in fulfillment of said specific resource request.

2. The method of brokering a resource associated with a subscriber device in a social network with another subscriber device in said social network according to claim 1, further comprising:
associating a trust level with said registered resource;

3. The method of brokering a resource associated with a subscriber device in a social network with another subscriber device in said social network according to claim 2, wherein:
said trust level is established by at least one subscriber to said social network.

4. The method of brokering a resource associated with a subscriber device in a social network with another subscriber device in said social network according to claim 1, further comprising:
associating a relevant heuristic with said registered resource, said relevant heuristic being provided by said given subscriber.

5. The method of brokering a resource associated with a subscriber device in a social network with another subscriber device in said social network according to claim 4, wherein said relevant heuristic comprises:
hours of a day associated with said resource.

6. The method of brokering a resource associated with a subscriber device in a social network with another subscriber device in said social network according to claim 4, wherein said relevant heuristic comprises:
a location of said resource.

7. The method of brokering a resource associated with a subscriber device in a social network with another subscriber device in said social network according to claim 1, wherein said resource comprises:
a manual labor skill.

8. The method of brokering a resource associated with a subscriber device in a social network with another subscriber device in said social network according to claim 1, wherein said resource comprises:
a professional skill.

9. A method of performing crowd-sourced resource selection on a social networking service, without a ratings database, comprising:
receiving a skill request from a social network subscriber device, at a resource selection server, said skill request including at least one skill of interest and a relevant resource heuristic;
compiling a list of potential resources that meet said skill request via a query to a database of subscriber trust levels and skills;
identifying at least one social network subscriber device within ‘n’ degrees of separation of said requesting social network subscriber device, said at least one social network subscriber device having a trust rating associated therewith; and
returning to said requesting social network subscriber device, said list of potential resources based on aggregate trust factors;
whereby said list of potential resources represent best-fit resources registered on said social networking service to fulfill said skill request.

10. A method of performing crowd-sourced resource selection on a social networking service, without a ratings database, according to claim 8, further comprising:
ordering said list of potential resources from greatest to least best fit match according to trust ratings previously stored in said database of subscriber trust levels and skills.

11. A method of performing crowd-sourced resource selection on a social networking service, without a ratings database, according to claim 8, further comprising:
prompting said at least one social network subscriber device within ‘n’ degrees of separation of said requesting social network subscriber device to submit a real-time trust rating for a potential resource in said compiled list of potential resources.

12. A method of performing crowd-sourced resource selection on a social networking service, without a ratings database, according to claim 8, further comprising:
computing an aggregate trust factor for each potential resource compiled in said list of potential resources.

13. A method of performing crowd-sourced resource selection on a social networking service, without a ratings database, according to claim 8, wherein:
said aggregate trust factor reflects an average trust rating said potential resource has received via said real-time trust ratings submitted by said at least one social network subscriber device within ‘n’ degrees of separation of said requesting social network subscriber device.

14. A method of directly connecting a requesting social network subscriber device and a selected best-fit resource associated with another social network subscriber device, comprising
prompting a requesting social network subscriber device to select a best fit-resource for potential fulfillment of a skill request, said best-fit resource chosen from a plurality of potential resources having suitable aggregate trust factors for said skill request;
transmitting a message to a social network subscriber device associated with each best-fit resource selected by said requesting social network subscriber device to confirm availability;
returning an identity of a social network subscriber device associated with at least one best-fit resource having confirmed availability to said skill request; and
connecting said requesting social network subscriber device with said social network subscriber device associated with at least one best-fit resource having confirmed availability.

15. A method of directly connecting a requesting social network subscriber device and a selected best-fit resource associated with another social network subscriber device according to claim 14, wherein:
said requesting social network subscriber device is connected with said social network subscriber device associated with at least one best-fit resource having confirmed availability with anonymity of said requesting social network subscriber device being retained with respect to said social network subscriber device associated with said at least one best-fit resource having confirmed availability.
